(19) United States
(12) Patent Application Publication
(10) Pub. No.: US 2019/0044424 A1
(43) Pub. Date: Feb. 7, 2019

(54) MOTOR DRIVER

(71) Applicant: PRODRONE CO., LTD., Nagoya-shi, Aichi (JP)

(72) Inventors: Kiyokazu SUGAKI, Nagoya-shi (JP); Kazuo ICHIHARA, Nagoya-shi (JP)

(73) Assignee: PRODRONE CO., LTD., Nagoya-shi, Aichi (JP)

(21) Appl. No.: 16/073,230

(22) PCT Filed: Jan. 12, 2017
(86) PCT No.: PCT/JP2017/000723

§ 371 Date: Jul. 26, 2018

(30) Foreign Application Priority Data
Feb. 16, 2016 (JP) 2016-027042

(51) Int. Cl. H02K 29/08; H02K 11/215

(52) U.S. Cl. CPC H02K 29/08; H02P 6/16; H02K 11/215

(57) ABSTRACT

A motor driver for an outer-rotor sensorless brushless motor (hereinafter simply referred to as “motor”), the motor driver including: an external magnetic sensor; and a drive circuit. The external magnetic sensor is configured to detect a leakage flux of a permanent magnet of the motor at an outside of the motor, the permanent magnet being arranged on an inner circumferential surface of a rotor of the motor. The drive circuit is configured to control rotation of the motor based on: a control signal for the motor input into the drive circuit; and feedback input into the drive circuit from the external magnetic sensor.

### TECHNICAL FIELD

The present invention relates to a motor driver. More specifically, the present invention relates to a motor driver for an outer-rotor sensorless brushless motor.

### BACKGROUND ART

Conventionally, brushless motors have been widely used as motors that have overcome structural shortcomings of commutator motors. A commutator motor has such a structure that coils are included in a rotor and permanent magnets are included in a stator. The commutator motor rotates the rotor by controlling commutation timing of each coil of the rotor by using a commutator and brushes as a mechanical switch. By contrast, a brushless motor has such a structure that permanent magnets are included in a rotor and coils are included in a stator. The brushless motor rotates the rotor by electronically controlling commutation timing of each coil of the stator using an inverter circuit. In the brushless motor, the inverter circuit plays the roles of the brushes and the commutator of the commutator motor. Thus, the brushless motor generates no electric noise or mechanical noise that would otherwise be caused by a mechanical contact between the brushes and the commutator. This makes the brushless motor superior in motor life, maintainability, and quietness.

There are two types of brushless motors: sensored brushless motors and sensorless brushless motors. A sensored brushless motor is a brushless motor in which a plurality of magnetic sensors such as Hall effect ICs are arranged. The sensored brushless motor employs a method of detecting the positional angle, rotation angle, rotation speed (the number of rotations), and rotation direction (hereinafter occasionally collectively referred to as “positional angle and other parameters”) of a rotor based on feedback from the plurality of magnetic sensors. A sensorless brushless motor is a brushless motor employing a method of detecting the positional angle and other parameters of the rotor without using magnetic sensors. A typical sensorless brushless motor uses counter-electromotive force of coils to detect the positional angle and other parameters of the rotor.

An advantage of the sensored brushless motor is that the sensored brushless motor is capable of identifying the positional angle and other parameters of the rotor with high accuracy, including the positional angle and other parameters of the rotor in stationary state. Other advantages are that since the sensored brushless motor does not need to carry out a step of calculating the positional angle and other parameters of the rotor from counter-electromotive force, the motor responds quickly, maintains a high level of torque even when the motor is rotating at low speed, and ensures high power efficiency. On the other hand, a disadvantage of the sensored brushless motor is that the sensored brushless motor cannot be used in high temperature environments due to a temperature restriction of Hall effect ICs typically used as magnetic sensors. Another disadvantage is that a large number of wires are used to connect a motor and a drive circuit to each other, resulting in complicated cabling and increased cost of the sensored brushless motor compared with the sensorless brushless motor.

An advantage of the sensorless brushless motor is that since the magnetic sensors are unnecessary, the sensorless brushless motor can be used even in high temperature environments. Another advantage is that cabling is simple due to a small number of wires. Still another advantage is that cost of the sensorless brushless motor is low compared with the sensored brushless motor. A disadvantage of the sensorless brushless motor is that achievable rotation speed is limited due to a time constant of a circuit for detecting counter-electromotive force. Another disadvantage is that the sensorless brushless motor is not suitable for such operations that repeat acceleration and deceleration. Still another disadvantage is that since counter-electromotive force is generated by rotation of the rotor, control is complicated; for example, the rotation direction needs to be changed after the rotor has started.

### CITATION LIST

### Patent Literature

PTL1: JP S58-172993 A

PTL2: JP H01-008890 A

### SUMMARY OF INVENTION

### Technical Problem

As described above, both the sensored brushless motor and the sensorless brushless motor have advantages and disadvantages. A choice between the sensored brushless motor and the sensorless brushless motor depends on the application in which the motor is used and/or on how much cost is acceptable. However, even if a sensorless brushless motor, for example, is used in a device, there are some cases where using a sensored brushless motor is more preferable for the device, depending on the purpose of the device.

Generally, in a device in which a sensorless brushless motor is pre-mounted, when the sensorless brushless motor is replaced with a sensored brushless motor, it is necessary to replace both the motor and a drive circuit, which is a significant waste of cost. Moreover, a motor such as an outer-rotor motor has fewer types available than an inner-rotor motor. In the case of such motor, it may be impossible to find a sensored brushless motor to substitute the above motor, making replacement of the motor itself difficult. Further, a motor with the outer-rotor structure has a small internal space, making it difficult to mount a sensor in the motor after the motor has been assembled.

In view of the above-described circumstances, a problem to be solved by the present invention is to provide a motor driver that provides characteristics of a sensored brushless motor to an outer-rotor sensorless brushless motor.

### Solution to Problem

In order to solve the above-described problem, the present invention provides a motor driver for an outer-rotor sensorless brushless motor (hereinafter occasionally simply referred to as “motor”), the motor driver including: an external magnetic sensor; and a drive circuit. The external magnetic sensor is configured to detect a leakage flux of a permanent magnet of a rotor from an outside of the rotor, the permanent magnet being arranged on an inner circumferential surface of the rotor of the motor. The drive circuit is configured to drive the motor based on: a control signal for the motor input into the drive circuit; and feedback input into the drive circuit from the external magnetic sensor.

In an outer-rotor motor, a plurality of permanent magnets are arranged on the inner circumferential surface of a motor case, and the motor case itself rotates as a rotor. The plurality of permanent magnets are arranged in the circumferential direction of the inner circumferential surface of the motor case such that magnetic poles of the adjacent permanent magnets are opposite to each other. A magnetic flux of each of the plurality of permanent magnets slightly leaks to the outside of the motor case. An external magnetic sensor detects a leakage flux and feeds back the leakage flux to a drive circuit. This ensures that a sensorless brushless motor is controlled as if the sensorless brushless motor were a sensored brushless motor.

It is preferable that the external magnetic sensor include a sensor including a Hall element, and be configured to feed back a Hall effect voltage to the drive circuit as an analog signal, the Hall effect voltage being generated by a magnetic field of the leakage flux.

Generally, many sensored brushless motors use Hall effect ICs as magnetic sensors. This is because the Hall effect ICs are arranged at optimal positions inside the motor, and thus using a digital value for determination enables the positional angle and other parameters of the rotor to be identified more easily and more accurately. In the configuration according to the present invention, Hall elements are used as the magnetic sensors, and an analog signal is intentionally used to represent a Hall effect voltage. This ensures that the positional angle and other parameters of the rotor are identified through a slight increase or decrease in the strength of the leakage flux. It is noted that a plurality of Hall effect ICs may be used in place of the Hall elements. In this case, there is such a production difficulty that it is necessary to precisely adjust the intervals of the Hall effect ICs, making it necessary to adjust the intervals between the Hall effect ICs on an individual-motor basis. While there are this and other production difficulties, using the Hall effect ICs can implement approximately the same functions as when using Hall elements.

It is preferable that the external magnetic sensor include a plurality of external magnetic sensors arranged in a circumferential direction of the rotor.

The leakage flux is detected not only from one point but also from a plurality of points in the circumferential direction of the rotor. This ensures that even when the rotor is in stationary state, the positional angle of the rotor is identified. Moreover, since the arrangement of magnetic poles of the permanent magnets of the rotor in stationary state can be identified, the rotor can be caused to rotate in a desired direction at the start of the motor. This ensures a smooth start operation of the motor.

It is preferable that the external magnetic sensor include a plurality of external magnetic sensors arranged in a circumferential direction of the rotor, and the permanent magnet include a plurality of permanent magnets arranged on the inner circumferential surface of the rotor. It is also preferable that the plurality of external magnetic sensors be arranged at intervals each being narrower or wider than a width in a rotation direction of each of the permanent magnets.

The plurality of external magnetic sensors are arranged at intervals each being different from the width in the rotation direction of each of the permanent magnets. With this configuration, an approximate positional angle of the rotor can be identified by simply determining whether the adjacent external magnetic sensors indicate the same magnetic pole or different magnetic poles.

It is preferable that the drive circuit be configured to adjust an advance angle of the motor according to a rotation speed of the motor so as to maximize a torque at a moment.

The advance angle is dynamically optimized according to the rotation speed (the number of rotations) of the rotor. This ensures that even though the sensorless brushless motor is used, a high level of torque is maintained regardless of whether the rotor is rotating at low speed or rotating at high speed.

It is preferable that the external magnetic sensor include a unit of two magnetic sensors, the two magnetic sensors including a main sensor and a secondary sensor, the main sensor and the secondary sensor being arranged side by side in a direction parallel to an axial direction of the rotor.

The two magnetic sensors arranged vertically (in a direction parallel to the axial direction) with respect to the rotor are treated as one unit. With this configuration, it is possible to take an average value between values of the two magnetic sensors. This improves the accuracy of detecting the positional angle and other parameters. Also with the above configuration, the secondary sensor can be used as a backup in case of failure of the main sensor, resulting in improved reliability.

The motor driver may further include a sensor adapter mounted on the motor. The external magnetic sensor may be fixed to the sensor adapter. With the sensor adapter mounted on the motor, the external magnetic sensor maybe located at a position of a portion of the sensor adapter, the position being arranged laterally close to the motor.

The sensor adapter may include: a bottom portion coupled to a bottom surface of the motor; and a side portion located beside the motor. The side portion may extend vertically from a top surface of the bottom portion. The side portion may be located at a position along a shape of an outer circumferential surface of the rotor of the motor and located over a range that covers at least a portion in a circumferential direction of the outer circumferential surface of the rotor, a small gap being defined between the side portion and the outer circumferential surface of the rotor. The external magnetic sensor may be arranged at the side portion of the sensor adapter.

The motor driver further includes the sensor adapter to arrange the external magnetic sensor in the vicinity of the rotor. This facilitates the position adjustment of the external magnetic sensor.

### Advantageous Effects of Invention

Thus, the motor driver according to the present invention provides characteristics of a sensored brushless motor to an outer-rotor sensorless brushless motor.

### BRIEF DESCRIPTION OF DRAWINGS

FIG. 1 is a block diagram illustrating a functional configuration of an unmanned aerial vehicle according to an embodiment.

FIG. 2 is a plan view of a cross-section of a motor.

FIGS. 3A and 3B respectively illustrate a perspective view and a front view of an external appearance of a sensor adapter.

FIGS. 4A and 4B illustrate steps of mounting the sensor adapter.

### DESCRIPTION OF EMBODIMENTS

An embodiment of the present invention will be described in detail below by referring to the drawings. The following embodiment is an example in which a motor driver according to the present invention is applied to an unmanned aerial vehicle including a plurality of propellers. The unmanned aerial vehicle according to this embodiment is a product equipped with an outer-rotor sensorless brushless motor, and the original motor driver has been replaced with the motor driver according to the present invention.

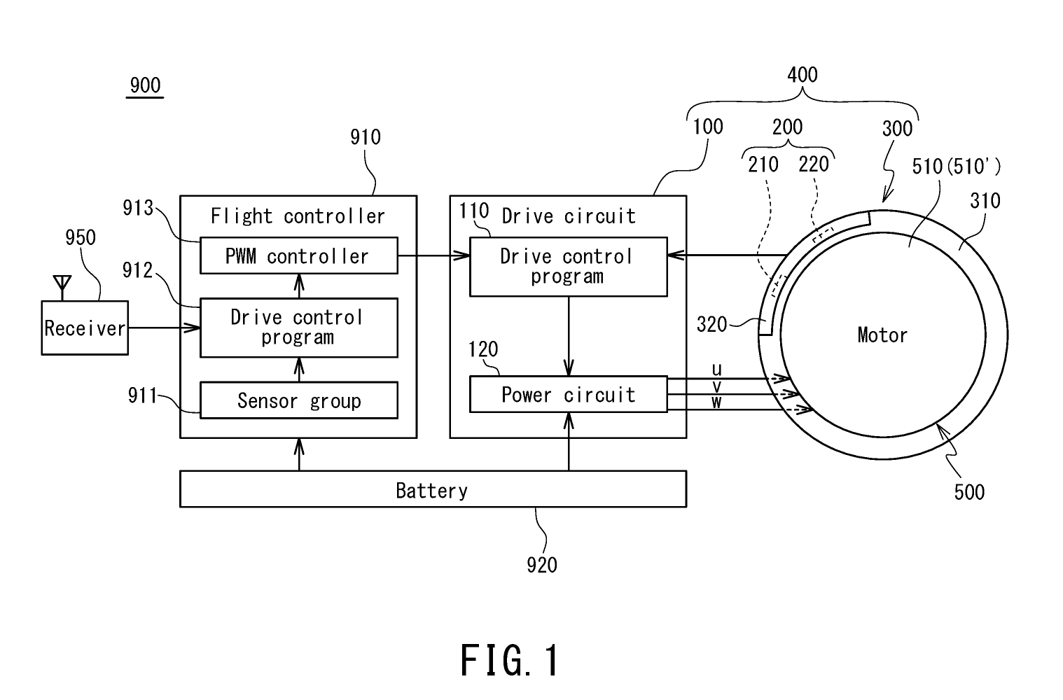

FIG. 1 is a block diagram illustrating a functional configuration of an unmanned aerial vehicle 900. Main functions of the unmanned aerial vehicle 900 according to this embodiment include: a flight controller 910, described later; a motor driver 400, described later; a motor 500, described later; a receiver 950, which receives an operation signal from an operator of the unmanned aerial vehicle 900; and a battery 920, which supplies power to each device of the unmanned aerial vehicle 900.

### [Configuration of Flight Controller]

Functions of the flight controller 910 mainly include a sensor group 911, a flight control program 912, and a PWM controller 913. The sensor group 911 obtains position information on the unmanned aerial vehicle 900 that includes, in addition to the inclination and rotation of the airframe, the current latitude, longitude, and altitude, and the azimuth of the head of the airframe. The flight control program 912 is a program that controls the posture and basic flight operation of the unmanned aerial vehicle 900 during a flight while taking an output value of the sensor group 911 into consideration. The PWM controller 913 is a device that converts a command from the flight control program 912 into a PWM signal (control signal) and transmits the PWM signal to the motor driver 400.

### [Configuration of Motor]

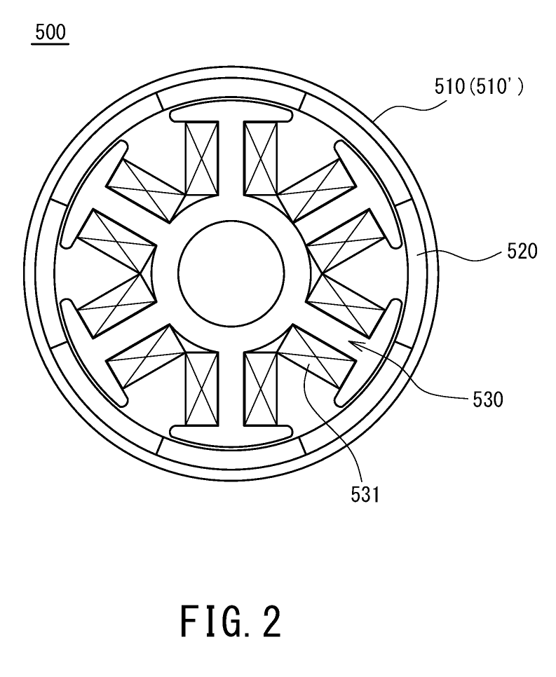

FIG. 2 is a plan view of a cross-section of the motor 500. The motor 500 is a typical outer-rotor sensorless brushless motor. Eight permanent magnets 520 are arranged on the inner circumferential surface of a motor case 510 of the motor 500, and the motor case 510 itself rotates as a rotor 510′. It is noted that “rotor” according to the present invention refers to the motor case 510. These eight permanent magnets 520 are arranged in the circumferential direction of the inner circumferential surface of the motor case 510 such that the magnetic poles of the adjacent permanent magnets 520 are opposite to each other. Since the motor case 510 acts as a yoke, the magnetic flux of each of the permanent magnets 520 slightly leaks to the outside of the motor case 510.

### [Configuration of Motor Driver]

### (General Arrangement)

The motor driver 400 is a motor driver dedicated to outer-rotor sensorless brushless motors such as the motor 500 according to this embodiment. As illustrated in FIG. 1, the motor driver 400 includes external magnetic sensors 200 (external magnetic sensors 210 and 220), a drive circuit 100, and a sensor adapter 300.

The flight control program 912 of the flight controller 910 issues a command to the motor 500. Examples of the command include start/stop, rotation direction (CW/CCW), and rotation speed (the number of rotations) of the motor 500. The PWM controller 913 converts the command into a PWM signal, and inputs the PWM signal into the drive circuit 100 of the motor driver 400. The drive circuit 100 is connected to coils 531 (see FIG. 2) of the motor 500 through lead wires u, v, and w. Based on the PWM signal (command from the flight control program 912) received from the PWM controller 913, the drive circuit 100 controls current flowing through the lead wires u, v, and w to drive the motor 500.

### (External Magnetic Sensors)

The external magnetic sensors 200 are magnetic sensors including Hall elements. The external magnetic sensors 200 are fixed to the sensor adapter 300, and detect leakage fluxes of the rotor 510′ at a position laterally close to the rotor 510′. A wiring 201 of the external magnetic sensors 200 is connected to the drive circuit 100. A Hall effect voltage is generated by a magnetic field of a leakage flux, and the external magnetic sensors 200 feed back the Hall effect voltage to the drive circuit 100 as an analog signal. (These magnetic sensors will hereinafter occasionally be referred to as “analog magnetic sensors”.) Generally, many sensored brushless motors use Hall effect ICs as magnetic sensors. In this embodiment, an analog signal is intentionally used to feed back a Hall effect voltage value. This configuration ensures that the positional angle and other parameters of the rotor 510′ are identified through a slight increase or decrease in the strength of the leakage flux. The analog magnetic sensors using the Hall element naturally include linear Hall effect ICs.

It is noted that the external magnetic sensors 200 may not necessarily be analog magnetic sensors. When the external magnetic sensors 200 need to ensure a particular level of accuracy, when a particular number of external magnetic sensors 200 are to be arranged, and/or when the external magnetic sensors 200 are to be arranged in particular positions, it is also possible to use typical Hall effect ICs (magnetic sensors that output an H or L digital value).

The two external magnetic sensors 200 according to this embodiment (external magnetic sensors 210 and 220) are arranged in the circumferential direction of the rotor 510′. The two external magnetic sensors 210 and 220 are arranged at an interval narrower than the width in the rotation direction of each of the permanent magnets 520 of the rotor 510′ (hereinafter occasionally simply referred to as “width of each of the permanent magnets 520”). With this configuration, an approximate positional angle of the rotor 510′ can be identified by, for example, simply determining whether the external magnetic sensors 210 and 220 indicate the same magnetic pole or different magnetic poles. This configuration improves the accuracy of detecting the positional angle of the rotor 510′ in stationary state, as compared with the case where there is only one external magnetic sensor 200.

Table 1 in the next paragraph illustrates a graph that models leakage fluxes (Hall effect voltage values) detected by the external magnetic sensors 210 and 220. The waveform indicated by the solid line represents Hall effect voltage values detected by the external magnetic sensor 210. The waveform indicated by the broken line represents Hall effect voltage values detected by the external magnetic sensor 220. Table 1 illustrates how the waveforms appear when the rotor 510′ has made one rotation in the clockwise direction (CW). An extreme value A on the positive side corresponds to the center in the width direction of each of the N-pole permanent magnets 520. An extreme value B on the negative side corresponds to the center in the width direction of each of the S-pole permanent magnets 520. It is noted that waveforms in actual situations do not appear as clearly as the waveforms illustrated in Table 1 due to interference between magnetic forces of a stator 530, which is in the motor 500, and the permanent magnets 520. Still, it suffices that similar characteristics of the waveforms are obtained, and there is no significant problem if waveforms are more or less distorted in actual operations.

It is noted that the number of external magnetic sensors 200 may not necessarily be two. The number of external magnetic sensors 200 may be one or may be three or more, depending on how much smoothness is necessary in a start operation and/or how much reliability is required. For example, if three external magnetic sensors 200 are arranged in the circumferential direction, failure of one of the external magnetic sensors 200 would not affect the performance of detecting the positional angle and other parameters. Thus, it is possible to provide dependability to the external magnetic sensors 200. It is noted that the effectiveness of providing two or more external magnetic sensors 200 can be observed mainly when the external magnetic sensors 200 identify the positional angle of the rotor 510′ in stationary state. Basically, once the rotor 510′ starts rotating, it is only necessary to monitor the rotation speed (the number of rotations) of the rotor 510′; thus, there is no significant difference in effectiveness between the case of one external magnetic sensor 200 and the case of a plurality of external magnetic sensors 200.

Moreover, the external magnetic sensors 200 may not necessarily be arranged at an interval narrower than the width of each of the permanent magnets 520. Contrarily, the external magnetic sensors 200 may be arranged at an interval wider than the width of each of the permanent magnets 520. It is noted, however, that for example, if the number of permanent magnets 520 is eight, as in this embodiment, and if the external magnetic sensors 200 are arranged at an interval of a multiple of 45° (360°/8), the external magnetic sensors 200 keep detecting the same magnetic pole or opposite magnetic poles at all times. In this case, arranging the plurality of external magnetic sensors 200 makes little sense. Therefore, it is preferable that the external magnetic sensors 200 be arranged at least at an interval other than an interval of a multiple of 360°/(the number of permanent magnets 520).

In this embodiment, “identifying the positional angle” does not mean identifying the absolute position (the positional angle within a range of 360°) of the rotor 510′, but means identifying the positional angle of the rotor 510′ within a range of 360°/(the number of permanent magnets 520)×2 (adjacent N pole and S pole). Specifically, in this embodiment, “identifying the positional angle” means identifying the positional angle of the rotor 510′ within a range of 90° anywhere within a range of 360°. As illustrated in Table 1, a combination of the values of the external magnetic sensors 210 and 220 is unique at any angle within any 90° range. While it is not possible to identify the absolute angle of the rotor 510′, insofar as the positional angle of the rotor 510′ can be identified within this range, it is possible to identify the arrangement of the magnetic poles of the permanent magnets 520 of the rotor 510′ at the present point of time. This configuration ensures that at the start of the motor 500 in stationary state, it is not necessary to temporarily start the motor 500 to adjust the rotation direction, and that the rotor 510′ is rotatable in a desired direction from the beginning. In other words, this configuration ensures a smooth start operation.

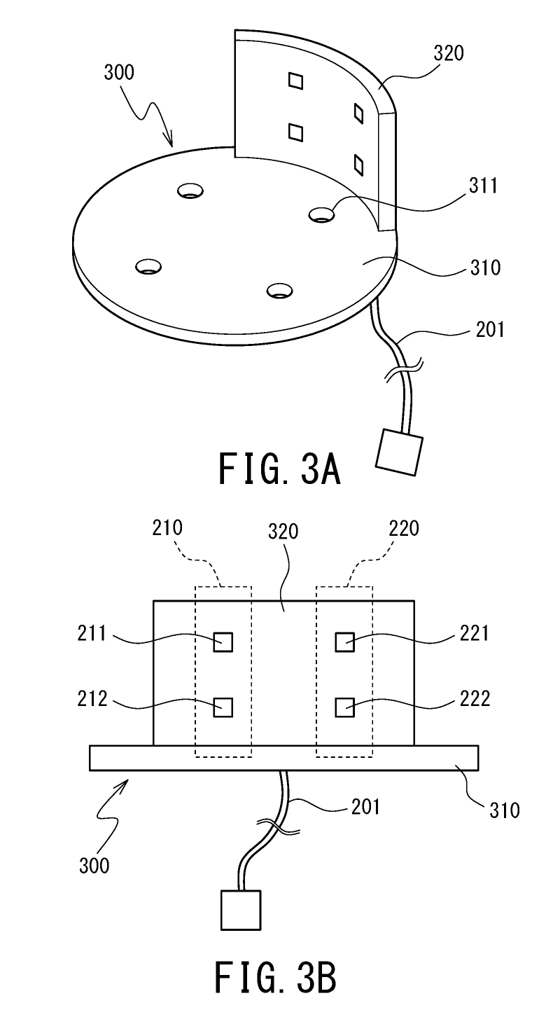

FIGS. 3A and 3B respectively illustrate a perspective view and a front view of the external appearance of the sensor adapter 300. As illustrated in FIG. 3B, each of the external magnetic sensors 210 and 220 includes a unit of two magnetic sensors. One unit includes a main sensor 211 and a secondary sensor 212. The other unit includes a main sensor 221 and a secondary sensor 222. The main sensors 211 and 221 and the secondary sensors 212 and 222 are arranged in a direction parallel to the axial direction of the rotor 510′. (The main sensors 211 and 221 and the secondary sensors 212 and 222 are arranged vertically in FIG. 3B.) In this embodiment, only the main sensors 211 and 221 are basically used as the external magnetic sensors 210 and 220. The secondary sensors 212 and 222 are used only if the main sensors 211 and 221 operate abnormally, such as when no feedback comes from the main sensors 211 and 221. A choice between the main sensors 211 and 221 and the secondary sensors 212 and 222 is not limited to the configuration according to this embodiment. One possible configuration is to take average values between the main sensors 211 and 221 and between the secondary sensors 212 and 222. Another possible configuration is to employ only either the main sensors 211 and 221 or the secondary sensors 212 and 222 based on which sensors exhibit clearer waveforms of Hall effect voltage values.

### (Drive Circuit)

The drive circuit 100 is a micro-controller that controls rotation of the motor 500 based on a PWM signal from the PWM controller 913 and based on feedback from the external magnetic sensors 200. A basic function of the drive circuit 100 is the same as a drive circuit (occasionally referred to as “ESC (Electric Speed Controller)” or “amplifier”) of a sensored brushless motor.

The drive circuit 100 mainly includes a drive control program 110 and a power circuit 120. The power circuit 120 includes an inverter circuit that includes transistors. The power circuit 120 switches ON/OFF of the transistors to reverse the direction in which current flows through the coils 531 of the stator 530. The drive control program 110 uses the PWM signal received from the PWM controller 913 and the positional angle and other parameters of the rotor 510′ that have been identified from feedback received from the external magnetic sensors 200 as as a basis of operating a base of each of the transistors through the power circuit 120 to control commucation timing of the coils 531.

In this manner, the leakage fluxes detected by the external magnetic sensors 200 are fed back to the drive circuit 100, and the drive circuit 100 causes the motor 500 to drive based on the feedback. This ensures that the sensorless brushless motor is controlled as if the sensorless brushless motor were a sensored brushless motor. In other words, a sensorless brushless motor can be provided with advantages of a sensored brushless motor. Specifically, even though the sensorless brushless motor is used, the positional angle and other parameters of the rotor 510′ can be identified with high accuracy, including the positional angle and other parameters of the rotor 510′ in stationary state. This enables the motor 500 to respond more quickly and maintain a high level of torque, even when the motor 500 is rotating at low speed. This, in turn, improves power efficiency.

The drive control program 110 of the drive circuit 100 includes a function that automatically adjusts the advance angle of the motor 500 according to the rotation speed of the motor 500 so as to maximize the torque at the moment. Generally, the torque of a motor peaks at a certain number of rotations, and decreases when the number of rotations increases or decreases from the peak. The drive control program 110 automatically performs control of increasing or decreasing the advance angle, depending on whether the rotation speed of the motor 500 has increased or decreased. This enables the motor 500 to maintain a high level of torque regardless of whether the motor 500 is rotating at low speed or rotating at high speed.

It is noted that the number of rotations within a predetermined period of time and the load corresponding to the number of rotations may be used as parameters to make an expression for calculating an optimal advance angle that corresponds to the rotation speed at the present point of time. Use of this expression as a function to obtain torque ensures that the torque is maximized regardless of the number of rotations. At present, however, there is no function commonly applicable to any kinds of motors. In light of the circumstances, it is necessary to subject each motor to be used to examination using an oscilloscope or another instrument, and to set parameter values in advance. It is noted, however, that if the number of poles and the number of slots are the same among motors, it is predicted that the parameter values are also approximately the same among the motors.

### (Sensor Adapter)

A configuration of the sensor adapter 300 will be described below by referring to FIGS. 1, 3A, and 3B. The sensor adapter 300 is a member that arranges and fixes the external magnetic sensors 200 to positions optimal for the external magnetic sensors 200 to detect leakage fluxes at positions laterally close to the rotor 510′. The sensor adapter 300 is a member made of resin or metal, and includes: a bottom portion 310, which has a flat circular shape and is screwed on the bottom surface of the motor 500; and a side portion 320, which extends vertically toward the motor 500 from an outer edge portion of the bottom portion 310. Along the shape of the outer circumferential surface of the rotor 510′, the side portion 320 is arranged over a range that covers a portion in the circumferential direction of the outer circumferential surface of the rotor 510′. A small gap is defined between the side portion 320 and the outer circumferential surface of the rotor 510′. The external magnetic sensors 200 are arranged on the side portion 320. Thus, with the sensor adapter 300 mounted on the motor 500, the external magnetic sensors 200 are arranged at positions laterally close to the rotor 510′.

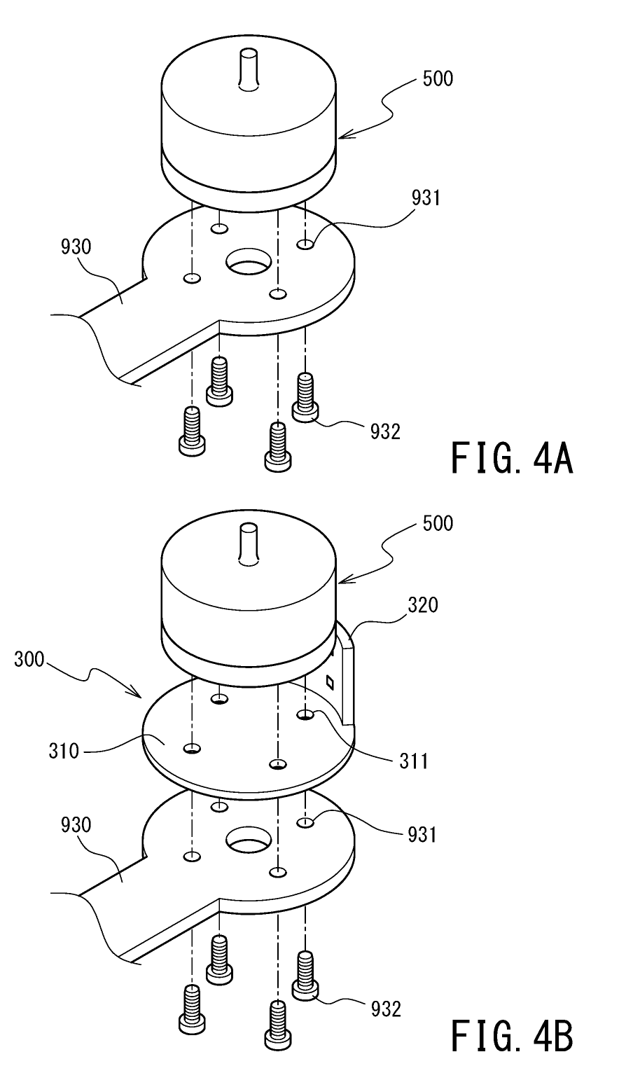

FIGS. 4A and 4B illustrate steps of mounting the sensor adapter 300. FIG. 4A illustrates the motor 500 that is being detached from an arm 930 of the unmanned aerial vehicle 900. When the motor 500 is detached from the arm 930, it is only necessary to simply remove set screws 932 coupling the motor 500 and the arm 930 to each other. FIG. 4B illustrates the sensor adapter 300 that is being mounted on the motor 500 and the arm 930. On the bottom portion 310 of the sensor adapter 300, through holes 311 are formed at the same positions as screw holes formed on the bottom surface of the motor 500. When the sensor adapter 300 is mounted, the bottom portion 310 of the sensor adapter 300 is held between the motor 500 and the arm 930, and the set screws 932 are attached to the motor 500 through the through holes 311 of the bottom portion 310.

The motor driver 400 according to this embodiment includes the sensor adapter 300. This configuration facilitates position adjustment of the external magnetic sensors 200, and also facilitates fixing of the external magnetic sensors 200 to positions optimal for the external magnetic sensors 200 to detect leakage fluxes. It is noted that the sensor adapter 300 is not an essential component. For example, when the airframe of the unmanned aerial vehicle 900 has a particular shape, the external magnetic sensors 200 may be directly fixed to the airframe of the unmanned aerial vehicle 900.

An embodiment of the present invention has been described hereinbefore. The present invention, however, will not be limited to the above-described embodiment but may have various modifications without departing from the scope of the present invention.

1-8. (canceled)

9. A motor driver for an outer-rotor sensorless brushless motor (hereinafter simply referred to as “motor”), the motor driver comprising:
an external magnetic sensor; and
a drive circuit,
wherein the external magnetic sensor is arranged laterally close to the motor, and is configured to detect a leakage flux of a permanent magnet of the motor at an outside of the motor, the permanent magnet being arranged on an inner circumferential surface of a rotor of the motor, and
wherein the drive circuit is configured to control rotation of the motor based on: a control signal for the motor input into the drive circuit; and feedback input into the drive circuit from the external magnetic sensor.

10. The motor driver according to claim 9, wherein the external magnetic sensor comprises a sensor comprising a Hall element, and is configured to feed back a Hall effect voltage to the drive circuit as an analog signal, the Hall effect voltage being generated by a magnetic field of the leakage flux.

11. The motor driver according to claim 9, wherein the external magnetic sensor comprises a plurality of external magnetic sensors arranged in a circumferential direction of the rotor.

12. The motor driver according to claim 9,
wherein the external magnetic sensor comprises a plurality of external magnetic sensors arranged in a circumferential direction of the rotor, and the permanent magnet comprises a plurality of permanent magnets arranged on the inner circumferential surface of the rotor, and
wherein the plurality of external magnetic sensors are arranged at intervals each being narrower or wider than a width in a rotation direction of each of the permanent magnets.

13. The motor driver according to claim 9, wherein the drive circuit is configured to automatically adjust an advance angle of the motor according to a rotation speed of the motor so as to maximize a torque at a moment.

14. The motor driver according to claim 9, wherein the external magnetic sensor comprises a unit of two magnetic sensors, the two magnetic sensors comprising a main sensor and a secondary sensor, the main sensor and the secondary sensor being arranged side by side in a direction parallel to an axial direction of the rotor.

15. The motor driver according to claim 9, further comprising a sensor adapter mounted on the motor,
wherein the external magnetic sensor is fixed to the sensor adapter, and
wherein with the sensor adapter mounted on the motor, the external magnetic sensor is located at a position of a portion of the sensor adapter, the position being arranged laterally close to the motor.

16. The motor driver according to claim 15,
wherein the sensor adapter comprises
a bottom portion coupled to a bottom surface of the motor, and
a side portion located beside the motor,
wherein the side portion extends vertically from a top surface of the bottom portion,
wherein the side portion is located at a position along a shape of an outer circumferential surface of the rotor of the motor and located over a range that covers at least a portion in a circumferential direction of the outer circumferential surface of the rotor, a small gap being defined between the side portion and the outer circumferential surface of the rotor, and
wherein the external magnetic sensor is arranged at the side portion of the sensor adapter.
